(19) United States
(12) Patent Application Publication
(10) Pub. No.: US 2025/0315910 A1
(43) Pub. Date: Oct. 9, 2025

(54) SYSTEMS AND METHODS FOR IMPROVING SPEED OF ELECTRONIC TRANSACTIONS

(71) Applicant: McKinley Technologies, Inc., Denver, CO (US)

(72) Inventor: Dillon Long, Denver, CO (US)

(21) Appl. No.: 18/630,624

(22) Filed: Apr. 9, 2024

(51) Int. Cl. G06Q 50/34; G07F 17/32

(52) U.S. Cl. CPC G06Q 50/34; G07F 17/323; G07F 17/3244; G07F 17/3288

(57) ABSTRACT

Embodiments provided herein include systems and methods for increasing speed of electronic transactions. One embodiment includes receiving a range wager for a first user on an event at a first wager unit amount and determining that a first partially matching wager is recorded for a second user that was placed with a second wager unit amount that is a fraction of the first wager unit amount of the range wager. Some embodiments include dividing the range wager into a plurality of divided wagers, where a first divided wager has a first divided unit amount equal to the second unit wager value and matching the first divided wager with the first partially matching wager. Some embodiments include determining the outcome for the event and providing a partial return, based on the first divided unit amount.

### TECHNICAL FIELD

Embodiments described herein generally relate to systems and methods for improving speed of electronic transactions and, more specifically, to embodiments for range wagering, order matching, and order processing.

### BACKGROUND

As electronic wagering has become legal in various states and thus more popular, online options for wagering on events have also become more popular. These online options typically find new wager types and more options than a traditional sportsbook. Additionally, the online wagering platforms strive to increase transaction speed such that the wagers that are being received are being received with the current odds that have expired.

As such, a need exists in the industry for systems and methods for improving speed of electronic transactions, as described herein.

### SUMMARY

Embodiments provided herein include systems and methods for increasing speed of electronic transactions. One embodiment of a method for increasing speed of electronic transactions via order matching includes receiving a range wager for a first user on an event at a first wager unit amount and determining that a first partially matching wager is recorded for a second user that was placed with a second wager unit amount that is a fraction of the first wager unit amount of the range wager. Some embodiments include dividing the range wager into a plurality of divided wagers, where a first divided wager has a first divided unit amount equal to the second unit wager amount and matching the first divided wager with the first partially matching wager. Some embodiments include determining the outcome for the event and providing a partial return, based on the first divided unit amount.

A system may include a computing device that includes a processor and a memory component, where the memory component stores logic that, when executed by the processor, causes the system to receive a range wager for a first user on an event at a first unit amount, where the range wager represents a prediction for an outcome of the event and a variable return is provided based on where the outcome falls with respect to the range. In some embodiments, the logic causes the system to access an order book to determine whether the order book currently records a fully matching wager and, in response to determining that the order book does not currently record a fully matching wager, determine whether the order book currently records a first partially matching wager for a second user that was placed with a second unit amount that is a fraction of the first unit amount of the range wager. Some embodiments cause the system to divide the range wager into a plurality of divided wagers, where a first divided wager has a first partial unit amount equal to the second unit amount, match the first divided wager with the first partially matching wager, determine the outcome for the event, and provide a partial variable return, based on the first partial unit amount.

Embodiments of a non-transitory computer-readable storage medium include logic that, when executed by a computing device, causes the computing device to receive a range wager for a first user on an event at a first unit amount, where the range wager represents a prediction for an outcome of the event and a variable return is provided based on how close the prediction is to the outcome, determine whether an order book currently records a fully matching wager to the range wager via at least one of the following: a standard match or an inverse match, and in response to not determining a fully matching wager is not currently recorded in the order book, determine a first partially matching wager that is currently recorded in the order book for a second user that was placed with a second unit amount that is a fraction of the first unit amount of the range wager. Some embodiments cause the computing device to divide the range wager into a plurality of divided wagers, where a first divided wager has a first divided unit amount equal to the second unit amount, match the first divided wager with the first partially matching wager, determine the outcome for the event, and provide a partial variable return, based on the first divided unit amount.

Some embodiments include a system for increasing speed of electronic transactions via range wagering. Some embodiments include a computing device that includes a processor and a memory component, wherein the memory component stores logic that, when executed by the processor, causes the system to determine an event for receiving a plurality of wagers, determine a payout range from the plurality of wagers, where the payout range includes a high bound and a low bound, and determine a bet direction for a wager. Some embodiments of the logic cause the system to receive the wager or a unit amount for the event from a user, determine an implied value of the event, based on the wager, and determine an outcome for the event. In some embodiments, the logic causes the system to calculate a payout amount to the user, wherein if the bet direction is an over wager, the payout amount linearly increases from the low bound to the high bound, where if the bet direction is an under wager, the payout amount linearly increases from the high to the low bound and pay the user the payout amount.

Some embodiments include a system for increasing speed of electronic transactions via order processing include a computing device that includes a processor and a memory component, the memory component storing logic that, when executed by the processor, causes the system to receive a first wager on an event for a first user and a second wager on the event for a second user, determine that the first wager and the second wager can be matched, and match the first wager and the second wager. In some embodiments, the logic causes the system to create a first order-to-contract (OTC) for the first user that indicates matching the first wager and the second wager, create a second OTC for the second user that indicates matching the first wager and the second wager, and create a first contract that represents a first portion of matching of the first wager and the second wager. Some embodiments of the logic cause the system to create a second contract that represents a second portion of matching of the first wager and the second wager, receive data associated with results of the event, determine a payment amount to at least one of the following: the first user or the second user, based on the first contract, the second contract, and the data, and make a payment of the payment amount.

Other embodiments provide methods for performing the functions of the aforementioned systems described herein; non-transitory, computer-readable media comprising instructions that, when executed by a processors of a processing system, cause the processing system to perform the methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a computing environment for order matching, according to embodiments provided herein;

FIGS. 2A-2E depict user interfaces for providing wagering options, according to embodiments provided herein;

FIGS. 3A-3D depict user interfaces for buying, selling, and trading orders, according to embodiments provided herein;

FIG. 4 depicts a flowchart for order matching, according to embodiments provided herein;

FIG. 5 depicts a flowchart for providing electronic range wagering, according to embodiments provided herein;

FIG. 6 depicts a flowchart for range wagering, according to embodiments provided herein;

FIG. 7 depicts a flowchart for order processing, according to embodiments provided herein; and

FIG. 8 depicts a remote computing device for order matching, according to embodiments provided herein.

### DETAILED DESCRIPTION

Embodiments disclosed herein include systems and methods for increasing speed of electronic transactions. Some embodiments are configured for range wagering, where a user is provided options to place a wager against a betting line. In traditional wagering, the payout to the user is binary in that the user either wins the amount wagered (minus the vig) or the user loses his/her wager. Conversely, embodiments provided herein vary the return to the user, based on how close or far the wager was to the event outcome. Specifically, these embodiments provide an electronic wagering platform that (a) creates a two-way sports betting market where a range (low bound to high bound) is set around a betting line (e.g., line+/−5, line+/−10); and (b) utilizes a price/time order matching feature.

Embodiments relate to a two-way sports betting market type where a range (low bound to high bound) is set around a betting line (e.g., line+/−5, line+/−10). Market participants can create a range wager on their belief of what the outcome will be by choosing a bet direction (over or under) and purchasing that contract (or “unit”) type for a given market. Each over unit always has a corresponding under unit, and the combined value of the two (collectively called a neutral position) always adds up to $100 (and/or other predetermined value).

This improves wagering by allowing users to have “skin in the game” with less risk of loss. If the user is incorrect, they may still receive a payout if the outcome falls within the range provided. Unit payouts are variable and may have a linear and/or proportional relationship with the predetermined range, with a maximum payout per unit of $100 (and/or other predetermined value) and a minimum payout of $0. Over payouts increase as the outcome approaches the high bound, and under payouts increase as the outcome approaches the low bound. This methodology is herein referred to as range betting or range wagering. These embodiments may be configured to support range wagers and facilitate trading, matching, and settlement of both full and partial over and under units via a central order book. The order book may be configured as a registry with bids (offers to buy) and asks (offers to sell) for each direction that have been placed and logged. In some embodiments, the order book may be configured to provide orders by best price in descending order, with the price offered per units as well as how many units are offered at that price.

Some embodiments are configured to provide an electronic wagering platform that includes a price/time order matching feature that will match orders with the best price available in the order book. For buy orders, this may be the lowest price for buy orders and the highest price for sell orders. If there are two orders with the same price, the first order placed at that price will be matched.

As such, these embodiments may be configured such that orders are matched on a price and/or time priority. Users can enter in a wager amount, which queries the order book to return a number of units to be bought or sold. This increases the speed of determining bet sizing. These embodiments search the order book for a best available price and, if there are multiple orders at that price, which order was submitted first to match. This increases the speed at which orders are matched, thus increasing the number of wagers that can be accepted by the system, because the system desires to match all orders to reduce financial risk. This allows faster response to receiving orders and matching those orders, thereby more likely securing accurate lines and prices of the orders before orders are completed. Orders can be matched one of two ways for each bet direction (over/under) and action (buy/sell). There are two types of matching: standard and inverse matching (IM), which is the same action for an opposite unit type at an inverse price.

As an example, the following types of matches may be employed: buying over —matched with counterparty selling over (standard) or buying under (IM); buying under—matched with counterparty selling under (standard) or buying over (IM); selling under—matched with counterparty buying under (IM) or selling over (standard); and selling over—matched with counterparty buying over (IM) or selling under (standard).

Each time a user selects a “place bet” or “cash out” option, an order is submitted. When an order is submitted, the market specific order book is queried to find matching limit (e.g., where an order is set to a maximum or minimum price as a condition of completion) orders. If there are not enough matching limit orders in the order book, the system will take the unmatched portion of the order and, if the order is a market order, cancel the remaining order. If the order is a limit order, embodiments will list the remaining open order in the order book. Limit orders will remain on the order book until they are matched, canceled by the user who placed the order, the market resolves, the user is suspended, or the market is canceled.

The following example process represents actions that may be taken for matching orders. Specifically, the process may include receiving user input regarding whether an order (e.g., a wager) is a market order or limit order; whether the order is a buy or sell; whether the order is for an “over” or an “under” wager. The process may next include determining whether the order can be matched with one or more existing orders in the order book. In response to determining that the order can be matched, the order will be matched by the counterpart (ies) who placed an open limit order in the order book via a price/time order matching system. Each order type can be matched via traditional (standard) matching, inverse matching, or a combination of both.

If a buy or sell order is matched via traditional (non-inverse) matching, the order will be considered a secondary trade (the previously purchased contract being bought or sold, buyer balance is reduced in the order book and seller balance is increased for same amount). If a buy order is matched via the inverse matching method it will be considered a primary issuance for buys (contracts will be generated for matched and the contracts issued to both users, reducing the account balances (e.g., a first account balance for the first user and a second account balance for a second user) for both users for their respective purchase amount) or a redemption for sells (contracts extinguished via order matching, increasing the account balance for both users for their respective sale amount). Additionally, embodiments may be configured to facilitate the buying or selling of partial contracts on wagers to facilitate the matching and proper sizing of wagers. As an example, if a match cannot be found for a particular wager, the wager may be split into a plurality of partial wagers at least one of which matches the order value a wager in the order book. Some embodiments may be configured to facilitate a buy or sale of a contract between a first user and a second user with a third user. The systems and methods for order matching incorporating the same will be described in more detail, below.

Embodiments provided herein may also include order processing. Order processing may include creation of an order-to-contract (OTC) and contract when a wager is matched and/or when a sale of a contract is performed. Specifically, when over and under buy orders are matched, embodiments generate valid buy OTCs and issue contracts to the users, reducing the users account balance by the purchase amount. OTCs may additionally be issued when an entire contract is sold and/or when a partial contract is sold. Embodiments may be configured to store an unlimited amount of contracts/partial contracts in each OTC and contract object on generation after matching.

### Embodiment of a System

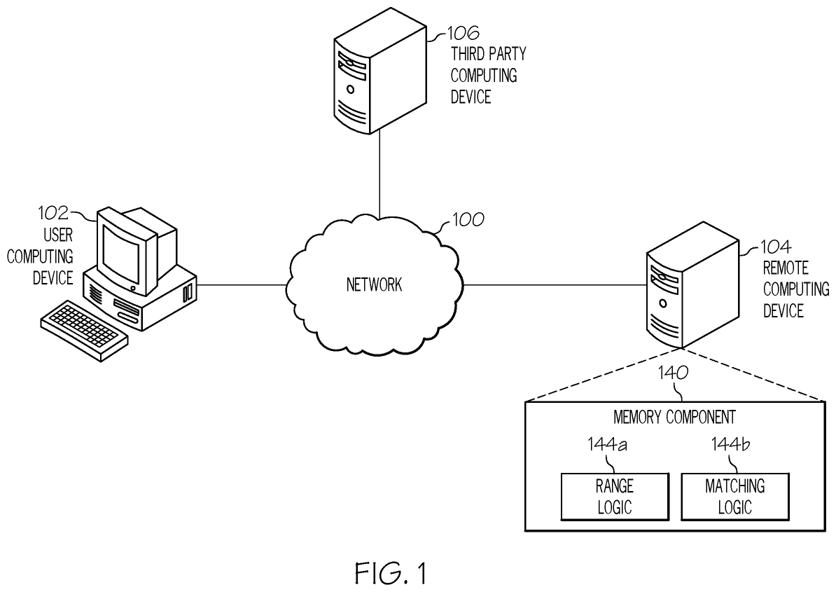

Referring now to the drawings, FIG. 1 depicts a computing environment for order matching, according to embodiments provided herein. As illustrated, a network 100 may be coupled to a user computing device 102, a remote computing device 104, and a third party computing device 106. The network 100 may include one or more wide area network (WAN), local area network (LAN), and/or personal area network (PAN). Example WANs might include the internet, a WiMax network, a cellular network, a public switched telephone network (PSTN), and/or the like. Example LANs might include an Ethernet network, a wireless fidelity (Wi-Fi) network, and/or the like. Example PANs might include Bluetooth, Zigbee, and/or other peer-to-peer networks.

Coupled to the network 100 is the user computing device 102. The user computing device 102 may include any personal computer, laptop, mobile device, or other computing device for receiving data from one or more of the other devices provided in FIG. 1, input from a user, and provide output, as provided herein. As described above, some embodiments may be configured for allowing a user to place wager, sell contracts, and/or perform other actions.

The remote computing device 104 is also coupled to the network 100. The remote computing device 104 may be configured as a server, personal computer, laptop, mobile device, and/or other computing device or virtual instance of a computing device for providing the functionality provided herein. The remote computing device 104 may include a memory component 140 that stores range logic 144a and matching logic 144b. As described in more detail below, the range logic 144a and the matching logic 144b represent software that is executed by the remote computing device 104, but in practice may be implemented by any number of pieces of software. That being said, in the example of FIG. 1, the range logic 144a may be configured to cause the remote computing device 104 to determine parameters for range wagering, as well as facilitate receiving range wagers from a user, and reconciling those wagers with a market maker. Similarly, the matching logic 144b may be configured to cause the remote computing device 104 to determine wagers and/or contracts that may be matched, as well as facilitating selling or otherwise reconciling those wagers.

The third party computing device 106 is also coupled to the network 100. The third party computing device 106 may be configured as a server, personal computer, laptop, mobile device, and/or other computing device or virtual instance of a computing device for performing market making activities.

### Example User Interfaces

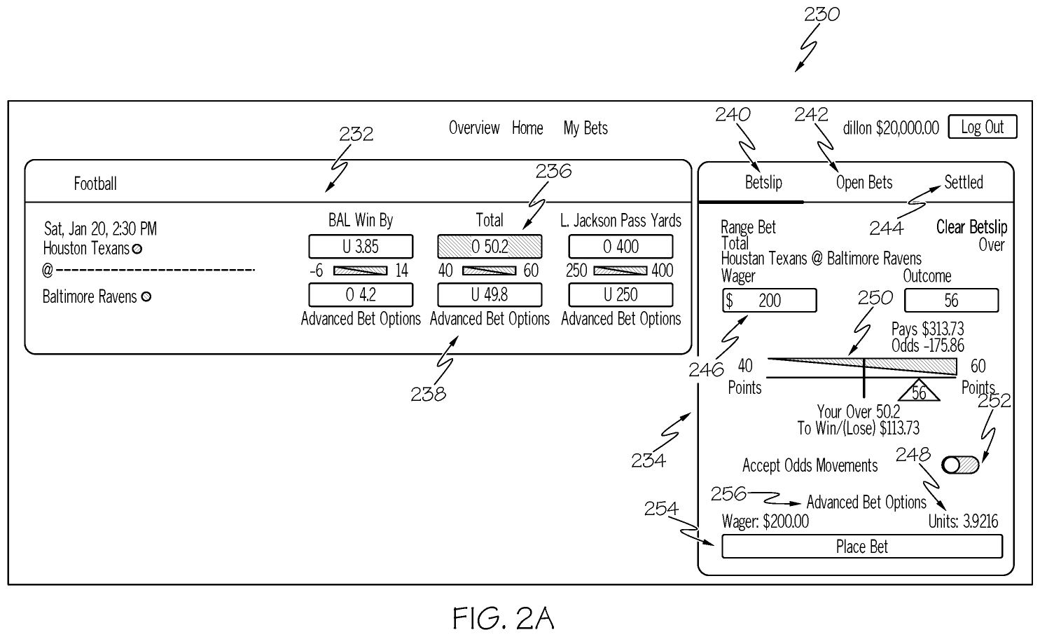

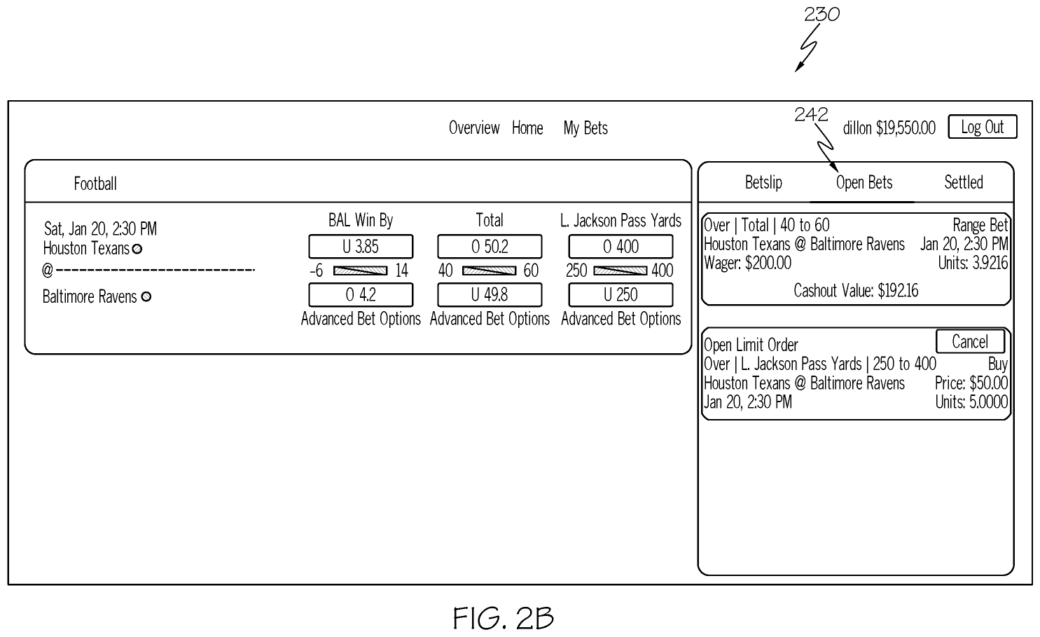

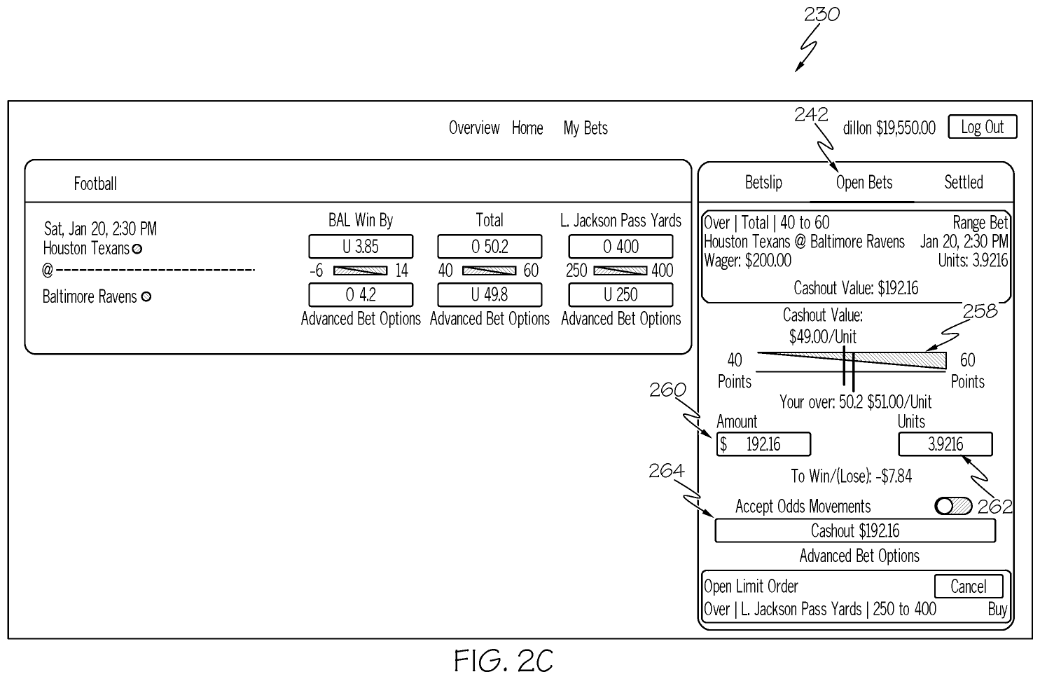

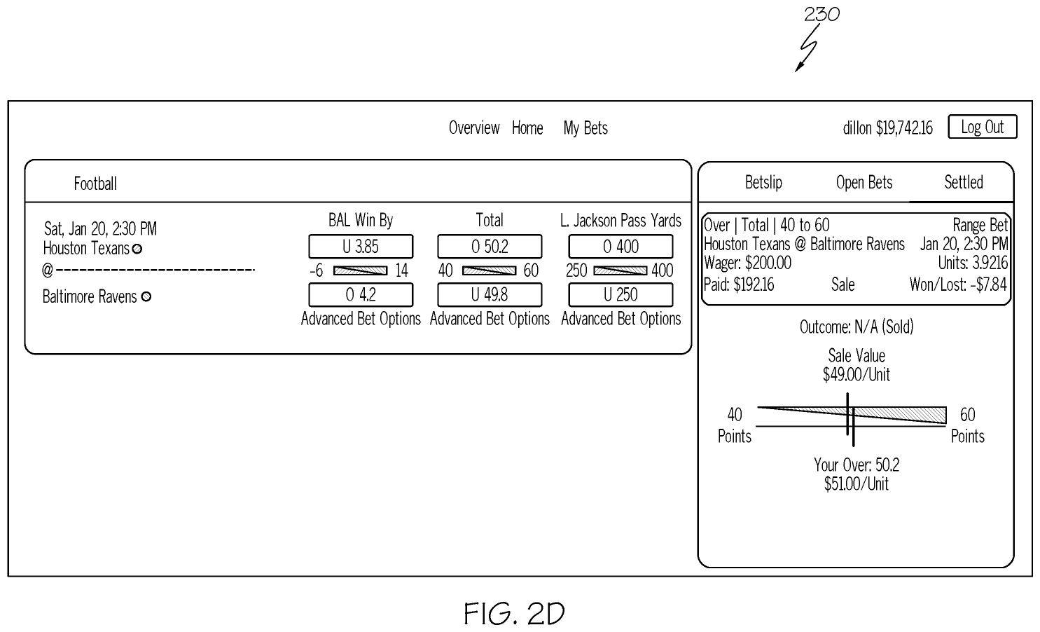

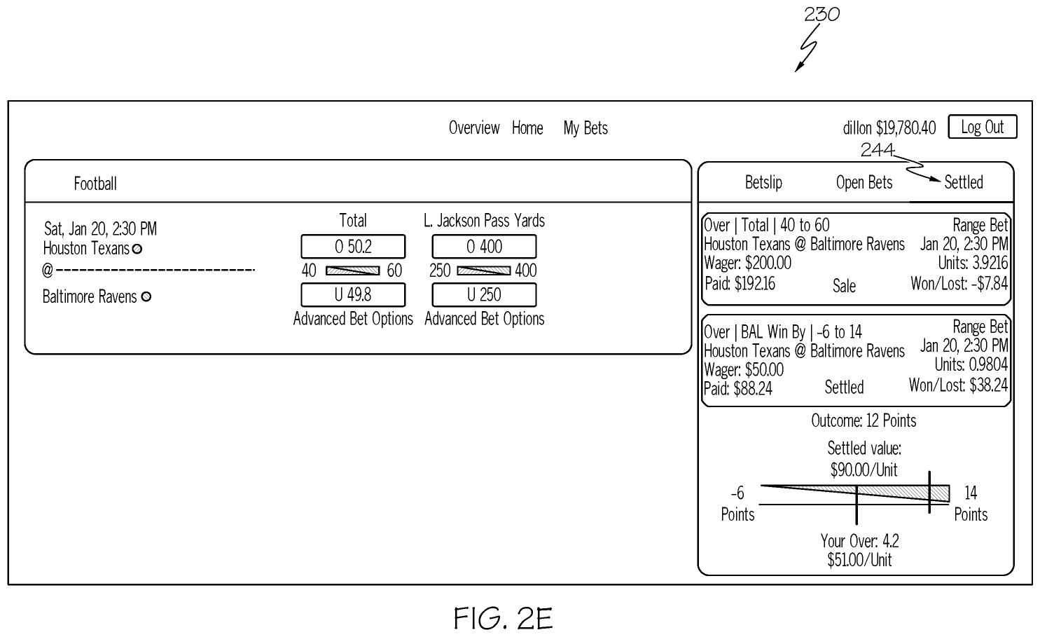

FIGS. 2A-2E depict a user interface 230 for providing wagering options, according to embodiments provided herein. As illustrated in FIG. 2A, the user interface 230 provides a plurality of markets that a user can select and allows users to trade market orders. Specifically, the user interface 230 includes an event section 232 and a wagering section 234. The event section 232 may provide the participants in the event. In the example of FIG. 2A, the event is a football game between the Houston Texans (e.g., a first participant) and the Baltimore Ravens (e.g., a second participant). Also provided in the event section 232 are various market types for each matchup. The market types may include spread, total prop, etc. The event section 232 may also include an over direction box 236, a market range (low bound to high bound) and an under direction box 238.

Each betting market has two direction boxes 236 (e.g., an over direction box 236 and an under direction box 238) that contain the betting line (or implied value (IV)) calculated based on the market price of one unit. The direction boxes 236, 238 may be separated by two stacked triangles that represent a linear relationship between unit payouts and the range. The low bound of the range is shown on the left side of the triangles and the high bound of the range is shown on the right side. The user may select either of the direction boxes 236 for any or all of the market types. In the example of FIG. 2A, the user has selected the direction box 236 indicating that the user believes that the outcome of the event will result in the participants scoring a combined total of more than 50.2 points. Upon making a bet direction selection, a bet slip will populate with wager and/or unit inputs, a payout calculator 250 and a place wager option 254 in the wagering section 234.

As illustrated, the wagering section 234 includes a bet slip tab 240, an open bets tab 242, and a settled bets tab 244. The bet slip tab 240 may provide a wager amount option 246. Specifically, a participant can size the wager by entering in a wager or unit amount. When a wager amount is submitted, a units field 248 will populate with the corresponding number of units to be purchased with that wager. This calculation is performed based on a preset value per unit. In some embodiments, a units amount may be received from the user and the wager amount option 246 will automatically populate with the cost of those units. Once the values are populated, a payout calculator 250 will be provided.

The payout calculator 250 provides a triangle for an under bet selection and an inverted triangle for an over bet selection. The low bound of the range (low end) is provided to the left of the triangle and the high bound (high end) of the range is provided to the right of the triangle. These values are also provided in the event section 232. The average per unit cost is displayed below the triangle along with the range betting line calculated off of that average cost (collectively the “cost details”). A line may be drawn from the cost details to the top of the triangle to show where the participant is buying within the range. A line may be drawn below the payout triangle from one end to the other, and a triangle below the line is displayed containing a potential outcome value (“outcome triangle”). A position of the outcome triangle can be adjusted by the user along the line and can reside on any value within the range including the low and high bounds. Stated another way, the payout calculator 250 may be configured to allow a user to scroll a plurality of outcomes to the event to calculate an expected payout of the range wager.

When the position of the outcome triangle is adjusted, the potential outcome value will update based on the position of the triangle with respect to the range and provided in the user interface 230. For each potential outcome, the pays value above the payout triangle will update to show the total payout associated with that outcome (pays/unit*units populated) as well as the odds associated with that outcome. The “to win/(lose)” amount below the triangles will update to show amount which subtracts the pays amount from the wager amount. The outcome can also be inputted into the outcome box and the outcome triangle will move to that position in the range and include that value inside the triangle.

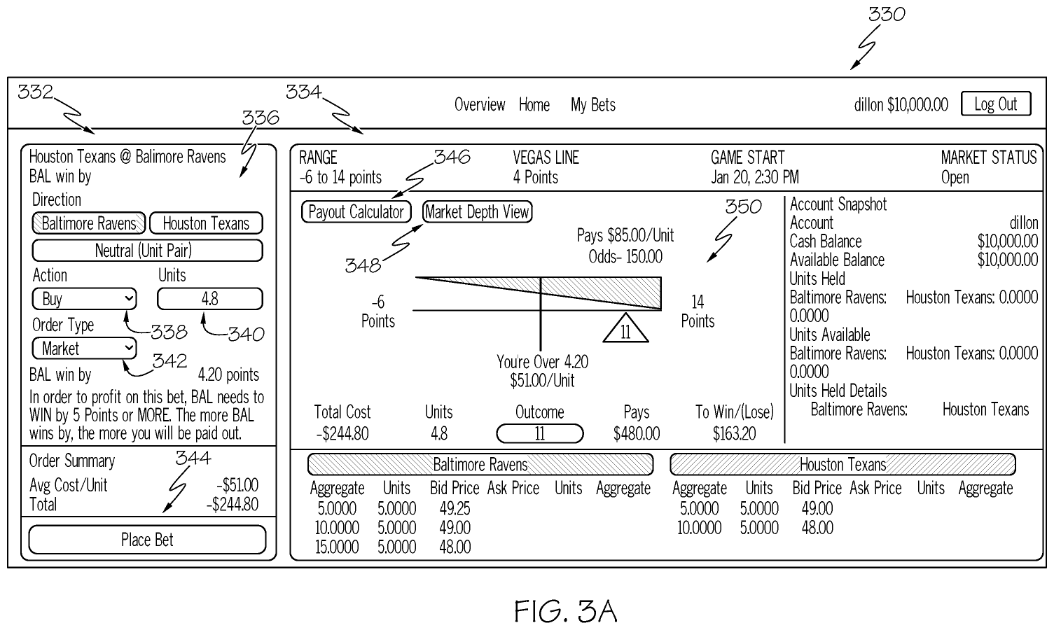

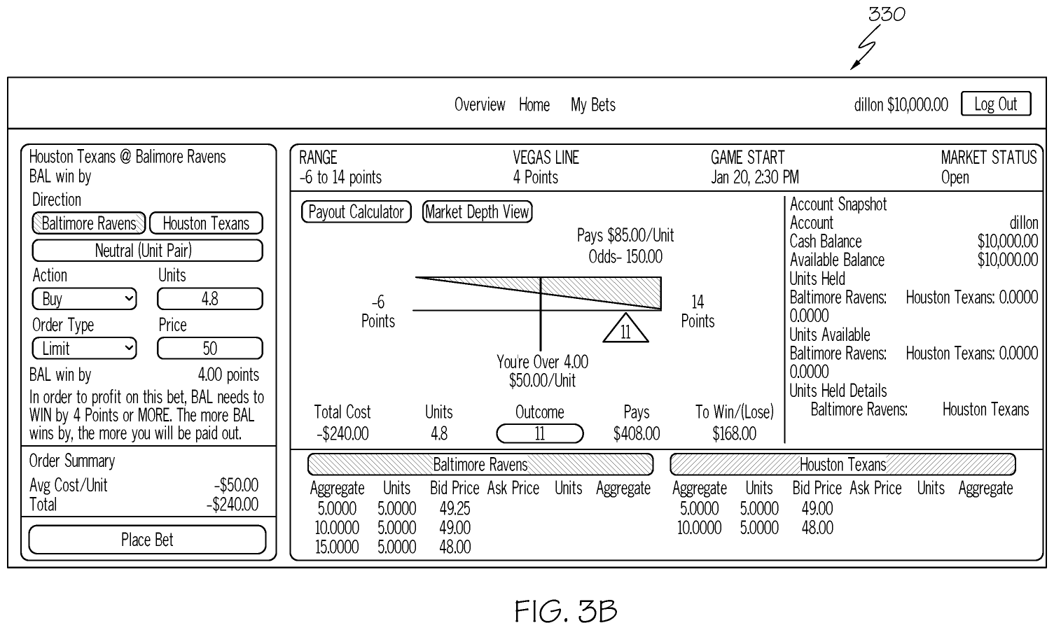

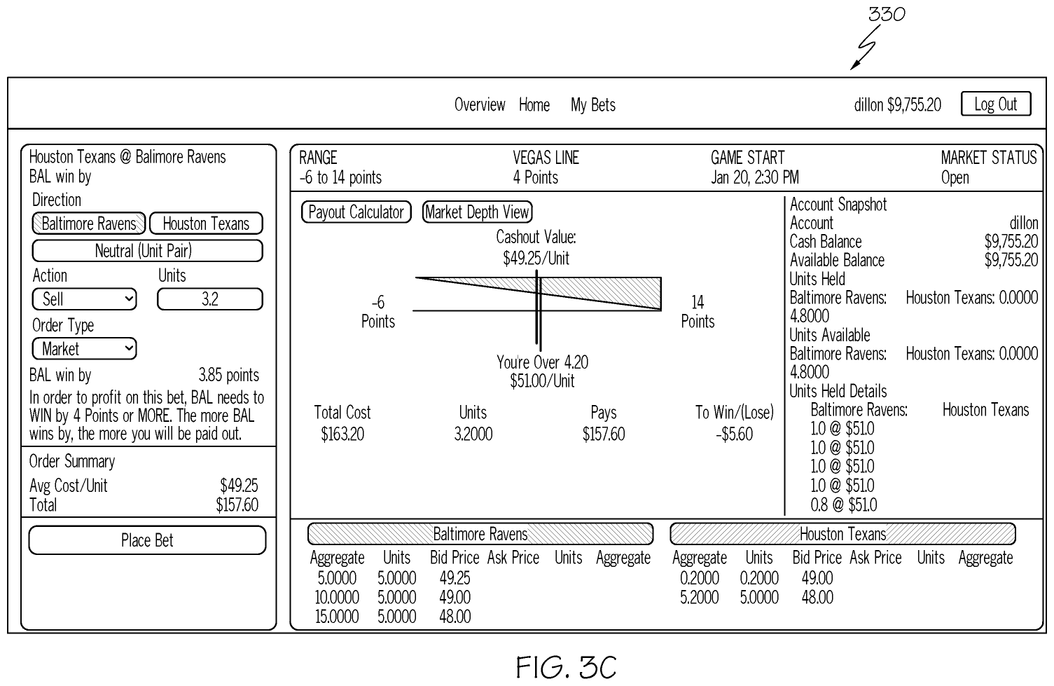

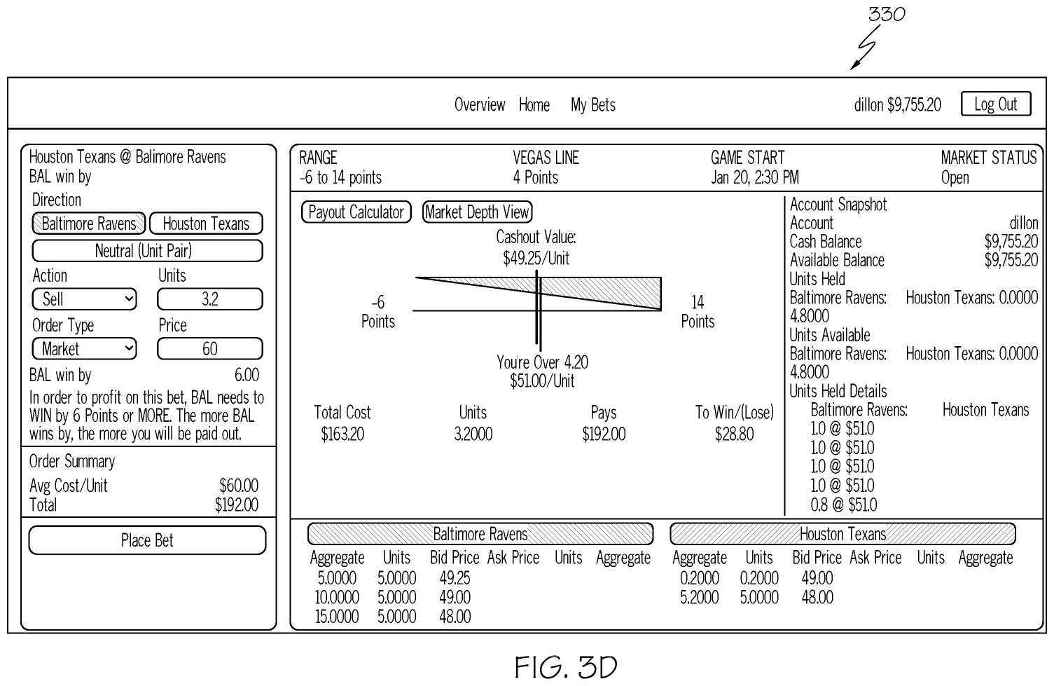

An odds movement option 252 may also be provided. In response to selection of the odds movement option 252, the odds of the wager may be adjusted after the wager has been made. In response to selection of a place wager option 254, the wager may be placed. An advanced wagering options option 256 may also be provided. In response to selection of the advanced wagering options option 256, the user may be taken to FIG. 3A.

FIG. 2B depicts the user interface 230, highlighting the open bets tab 242. Specifically, in response to selection of the open bets tab 242, open bets (e.g., bets owned by the user that have not been resolved or sold) may be provided to the user. This may include market details, bet direction and wager/units amounts (displayed in the aggregate for all transactions of that market/bet direction).

Options may also be provided for the user to sell a wager by selecting the relevant wager. As illustrated in FIG. 2C, upon selection of one of the open bets, a sell calculator 258 may also be included to provide the user a visual representation of the unit prices the user purchased and can sell the units. The sell calculator 258 includes a sale value per unit, the your over/under betting line, as well as the cost per unit of the purchase. This allows the user to toggle the amount and units field 248 to submit a full or partial sale of the units held. A user can enter the value or units that he/she wishes to sell in the amount field 260 or the units field 262. As described above, a user entering a value in the amount field 260 may automatically populate the units field 262, and vice versa. The user may select a cash out option 264 to complete the sale of the identified units.

As illustrated in FIGS. 2D and 2E, the settled bets tab 244 may be provided. Specifically, the user (e.g., the first user) may be provided with wagers that have been closed (e.g., sold, settled, or canceled). The wagers in the settled bets tab 244 may provide market details, bet direction, wager/units amounts (displayed in the aggregate), exit type (sold, settled, or canceled) and the amount won/lost on the bet. By selecting a wager in the settled bets tab 244, a settled triangle that includes the unit price they purchased the units and the unit price they were paid out may be provided.

FIGS. 3A-3D depict a user interface 330 for buying, selling, and trading orders, according to embodiments provided herein. In response to selection of the advanced wagering options option 256 of FIG. 2A, the user interface 330 may be provided. As illustrated, the user interface 230 provides a wagering section 332 and a calculator section 334. The wager section provides an option to select the direction of the wager by selecting one of the fields in the direction option 336. An action option 338 may allow the user to specify whether the user is buying (FIGS. 3A, 3B) or selling (FIGS. 3C, 3D) the wager. A units option 340 may provide a field for the user to enter the number of units (or dollar value) that are being wagered, sold, or bought. An order type option 342 may allow the user to select whether the transaction is a market order (FIGS. 3A, 3C), a limit order (FIGS. 3B, 3D), and/or other type of order.

Provided in the calculator section 334 is a payout calculator option 346 and a market depth view option 348. In response to selection of the market depth view option 348, data related to the market may be provided. In response to selection of the payout calculator option 346 and/or when a direction (over or under) is selected, a payout calculator 350 may be provided. After inputting a value into the units option 340, the user can utilize the payout calculator 350 to understand the projected payout, win/loss and odds associated with each potential outcome for the market. When a direction (over or under) is selected with a sell transaction (and the user owns units to sell), the payout calculator 350 may be provided. The units value will automatically populate with the number of units the user owns. The user can then utilize the payout calculator 350 to understand what the user's projected payout and win/loss would be on sale. When the user selects direction option 336 as neutral, a user can buy or sell a unit pair for the established unit price for the pair. Once all selections are made, a bet slip with the IV description and amount, a detailed description of what needs to happen in the game for the user to win the bet, and an order summary showing the Average (Avg) Cost/Unit−Avg Purchase Price (Buy) or Avg Sale Price (Sell), Total Cost−Market−Avg Cost/Unit*Inputted Units, Limit−Inputted Price*Inputted Units, Fees−Total Cost*Fee Percentage, and Total−Total Cost+Fees. To submit the wager, the user selects the place bet option 344.

### Back End Processing

Oftentimes there is a desire for the remote computing device 104 to match orders (or wagers) such that the total number of wagers includes an approximately equal amount wagered on each side of a wager. Because the remote computing device 104 may be accepting the wagers and taking a commission on the wager (e.g., the vig), in order to minimize risk for accepting any wager, there is an incentive to balance the amount of total bets placed on each side of a wager. Accordingly, embodiments may utilized any of three models: orders, order-to-contracts, and contracts.

### Order Matching

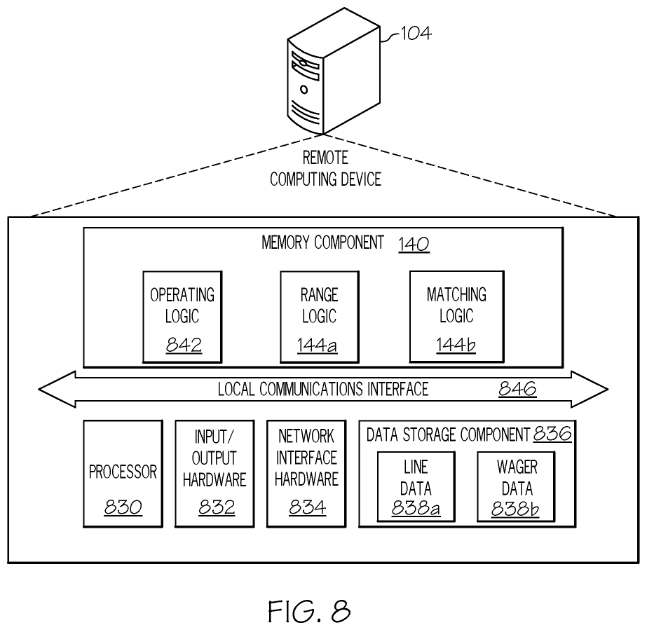

Embodiments provided herein may be configured to utilize a price/time order matching methodology, meaning that orders may be matched with the best price available in the order book (e.g., which is part of the order book data 838b in the remote computing device provided in FIG. 8). For buy orders this may be the lowest price available and for sell orders this may be the highest price available. If there are two orders with the same price, the first order placed at that price may be matched first (or other selection process may be implemented).

In response to a user selecting a place wager option 254 (FIG. 2A), 334 (FIGS. 3A-3D), and/or the cash out option 264 (FIG. 2C), an order may be submitted to the matching logic 144b (FIG. 1), which may cause the remote computing device 104 to place the order. When an order is placed, a market specific order book is queried from the matching logic 144b (FIG. 1) to find one or more matching limit orders. If there are not enough matching limit orders in the order book, the system will take the unmatched portion of the order and if the order is a market order, cancel the remaining order; if the order is a limit order, list the remaining open order in the order book. Limit orders will remain on the order book until they are matched with another user, canceled by the user who placed the order, the market resolves, the user is suspended, or the market is canceled.

### Example Process

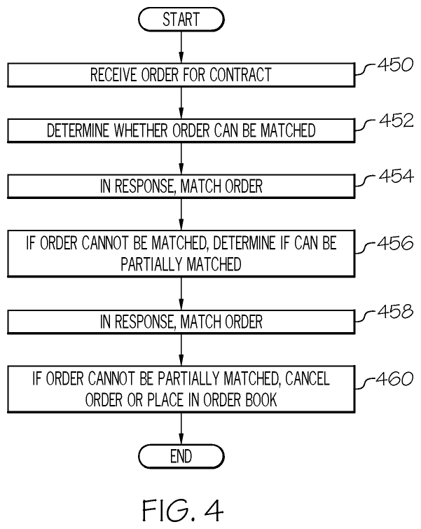

FIG. 4 depicts a flowchart for order matching, according to embodiments provided herein. As illustrated in block 450, embodiments may receive an order for contract. As discussed above, the order may include an indication that the order is a market or limit order, a buy or sell order, and/or an over or under order. In block 452, a determination may be made regarding whether the order can be matched with an existing order in the order book. In block 454, if the order can be matched with an existing order in the order book, the order will be matched. Each order type can be matched via the traditional method, the inverse matching method, or a combination.

If a buy or sell order is matched via a non-inverse process, the order will be considered a secondary trade (previously purchased contract being bought or sold, an entry for buyer balance is reduced and seller balance is increased for same amount). If a buy order is matched via the inverse matching process, the order may be considered a primary issuance for buys (e.g., contracts are generated for matched orders and the contracts are issued to both users, reducing the account balance for both users for their respective purchase amount). Alternatively or in addition, if a buy order is matched via the inverse matching process, the order may be considered a redemption for sells (e.g., contracts care extinguished via order matching, increasing the account balance for both users for their respective sale amount and/or contract amount).

In block 456, if the order cannot be matched with an existing order in the order book, a determination may be made regarding whether the order can be partially matched. In block 458, in response to determining that the order can be partially matched, the current order may be so matched. As described above, a determination may be made regarding whether either the current order or the existing order may be split into a smaller piece in order to match with the other. As an example, if the existing order is a buy order for 1 unit and the current order is a sell order of the same event for 0.6 units, a determination may be made that the current order may be split into a 0.4 unit order and a 0.6 unit order, thereby matching the existing order. The leftover 0.4 unit order may then be placed in the order book for future matching. If, in block 460, the order cannot be partially matched with an existing order in the order book, the order will be posted to the order book (if placed as a limit order) or canceled (if placed as a market order). When an order is fully filled, the order will be closed. When an order is partially matched with a partially matching order for a second user, the initial order will be reduced by the matched portion, remain open, and a new order object for the matched portion will be created marked as closed.

### Order-to-Contract (OTC) and Contracts

When orders are partially or fully matched, an order-to-contract (OTC) for each user involved in the matched orders may be created for every contract/partial contract that is being issued/redeemed (inverse matching) or sold (standard matching). OTCs will either issue, transfer, or redeem contracts depending on the order selection of the matching orders. OTCs may cause the remote computing device 104 to store the contract and order information for those orders. OTCs and contracts are generated as provided below.

### Initial Issuance (IM Buys)

When over and under buy orders are matched, embodiments may generate valid buy OTCs and issue contracts to the users, reducing the users' account balances by the purchase amount. Buyer matching can occur one of two ways: a market buy order interacting with a posted limit buy order and/or a limit buy order interacting with a posted limit buy order. In both cases, the cost is determined by the previously posted limit buy order. For example, if user A lists an under buy for $45 and user B is matched by placing either a market or limit order, user A's under cost will be $45 and user B's over cost will be $55 (thereby providing a neutral position of $100). The same logic applies for partial contract matching. Using the same example, if user B instead places an order to buy ½ contracts at market price, the cost values will be the same, but the total cost for user A will be $22.5 ($45*½), and the total cost for user B will be $27.5 ($55*½). Both the OTC and the contracts facilitate storage of the partial contract amount on matching (OTC-partial contract amount, contract-fraction amount).

### Traditional (Sells/Buys and Buys/Sells)

Contracts may be listed for sale at a listed amount if they are held by a user (e.g. the first user). Contracts can be listed for sale via either a market or a limit order and embodiments provided herein may be configured to broker that sale. When a user places a market or limit sell order and there is a posted limit buy order available, the orders will be matched at the price from that limit buy order. In the examples provided below, user B has posted a limit buy order and user A is selling to user B.

### Working Example: Market or Limit Sale—Entire Contract Sold

User A sells a contract to user B. When user A places a sell order and the entire contract is sold (e.g., user A owns 1 contract and sells 1 contract, or user A owns 0.4 contracts and 0.4 contracts are sold), the original buy OTC for user A will be switched from a valid label to an invalid label and marked as “dummy.” Additionally, two new OTCs will be generated. The first is that a valid buy OTC specifying buy price and partial contract amount of purchased contract will be generated for user B. The second is that an invalid sell OTC specifying sale price and partial contract amount (matches above) of sold contract will be generated for user A. Additionally, the owner user of the contract will flip from user A to user B.

### Working Example: Market or Limit Sale—Partial Contract Sold

User A sells a portion of a contract to user B. When user A places a sell order and the partial amount of the contract owned is sold (e.g., user A owns 1 contract and sell 0.8 contracts or user A owns 0.4 contracts and sells 0.2 contracts), the original buy OTC for user A will remain valid. The partial contract amount and total cost will be reduced by the amount transferred to user B. The original contract splits into two contracts. In this example, three new OTCs will be generated as a result of the transfer. The first will be for user B. Specifically, a valid buy OTC will be generated, specifying the buy price and partial contract amount of the contract purchased (new contract). The second will be for user A. Specifically, an invalid sell OTC specifying sale price and partial contract amount (matches above) of the portion of the contract that user A sold (new contract) will be generated. The third will be for user A. Specifically, an invalid “dummy” buy OTC specifying original buy price and sold partial contract amount will be generated.

The contract held by user A will split into two separate contracts (that sum to the original contract owned prior to sale); specifically, the new contract and old contract. The new contract with a fraction amount equaling the amount sold will be transferred to user B. Additionally, the old contract with a fraction amount equaling the original fraction amount less new contract fraction amount will be retained by user A.

### Working Example: Open Limit Sell Orders

When a user places a limit sell order and there is no matching posted limit buy or inverse match sell order available, the sell orders will flow to the order book as an open order. When user A places an unmatched limit sale order for an entire contract (e.g., user A owns 1 contract and posts a limit sell for 1 contract, or user A owns 0.4 contracts and posts a limit sale for 0.4 contracts), the original buy OTC for the contract listed for sale switches from “valid” to “invalid.” Additionally, one new OTC is created for user A. Specifically, a valid sell OTC is created specifying sale price and partial contract amount. As no transfer occurs, the contract object remains the same (user A is still the owner user (or first owner) of the contract).

### Working Example: Open Limit Sell—Partial Contract Listed for Sale

When user A places an unmatched limit sale order for a partial contract (e.g., user A owns 1 contract and posts a limit sell for 0.6 contracts, or user A owns 0.4 contracts and posts a limit sale for 0.3 contracts), the original buy OTC for the contract listed for sale remains valid and its partial contract amount is reduced by the amount listed for sale. The contract splits in two and two new OTCs are created. Specifically, a valid sell OTC is created specifying sale price and partial contract amount; and an invalid buy OTC is created for the amount listed for sale retaining original contract details (parent contract ID and purchase date/time). Additionally, the contract held by user A will split into two separate contracts (that sum to the original contract purchased by user A): the new contract (with a fraction amount equaling the amount listed for sale) and the old contract (with a fraction amount equaling the original fraction amount, less the new contract fraction amount), both of which are owned by user A.

### Open Limit Sell, Canceling Orders

Users can cancel their open limit sell orders at any time prior to the order being matched or market resolution with a cancellation request. When a sell order is canceled, the sell OTC switches from “valid” to “invalid” and the buy OTC flips from “invalid” back to “valid.”

### Working Example: Buys Interacting with Sell Limit Orders

When a user B places a market or limit buy order and there is a posted limit sell order available, the orders will be matched at the price from that limit sell order. In the below examples, user A has posted a limit sell order and user A is selling to user B.

### Working Example: Market or Limit Buy—Entire Contract Sold

User A has posted a limit sell order for $55. When user B places a buy order and user A's entire contract is sold (e.g., user A listed one contract for sale and sells one or user A lists 0.4 contracts for sale and 0.4 contracts are sold), the original sell OTC for user A will be switched from “valid” to “invalid.” As such, one new OTC will be generated. Specifically, a valid buy OTC specifying buy price and partial contract amount of the purchased contract is generated for user B. The owner user of the contract will switch from user A (first owner) to user B (second owner).

### Working Example: Market or Limit Buy—Partial Contract Sold

User A posts a limit sell order for $55. When user B places a buy order and a portion of user A's contract is sold (e.g., user A listed one contract for sale and sells 0.7, or user A lists 0.4 contracts for sale and 0.1 is sold), both the original buy OTC and limit sell OTC for user A will be reduced by the partial contract amount of the purchased contract. The original contract will split in two partial contracts and three new OTCs will be generated. Specifically, a valid buy OTC is generated for user A specifying buy price and partial contract amount of purchased contract. Second, an invalid sell OTC is generated for user A specifying sale price and partial contract amount of the sold contract. Third, an invalid dummy buy OTC is generated for user A, specifying the sale price and partial contract amount of the sold contract. The contract held (and listed for sale) by user A will split into two separate contracts (that sum to the original contract purchased by user A), new contract and old contract. The new contract may include a fraction amount equaling the amount sold will be transferred to user B. The old contract may include a fraction amount equaling the original fraction amount less new contract fraction amount will be retained by user A.

### Contract Extinguishment (IM Sells)

When over and under sell orders are matched, embodiments may facilitate the purchase of contracts from the sellers and may extinguish them, increasing the user's account balance by the sale amounts. Seller matching can occur via a market sell order interacting with a posted limit sell order and/or via a limit sell order interacting with a posted limit sell order. In both cases, the sale price may be determined by the previously posted limit sell order. For example, if user A lists an under sell for $60, user B may get matched with this order by placing either a market or limit sell order. In this case, user A's under sale price is $60 and user B's over sale price will be $40. The same logic holds true for partial contract matching. Using the same example, if user B instead places an order to sell 0.5 contracts at market, the sale price values will be the same. However, the total sale price for user A will be $30 ($60*0.5), and the total cost for user B will be $20 ($40*0.5). Additionally, the owner of the contract in the contract object will switch from the users to the administrator.

### Trading Neutral

In some embodiments, users can buy and sell neutral positions (or contract pairs) prior to market resolution. Specifically, if a user buys a neutral position, that user will send $100 (or a fraction thereof if buying a partial neutral position) in exchange for an over and an under contract. This mechanically works similar to an initial issuance (IM buys), but both valid OTC buys and contracts will belong to the user who purchased the neutral trade.

If a user sells a neutral position, they receive $100 (or a fraction thereof if selling a partial neutral position) in exchange for the contract pair they are redeeming. This mechanically works similar to contract extinguishment (IM sells). When selling neutral, the original buy OTCs of the contract(s) sold flip to invalid and are marked as “dummy.” In this scenario, four OTCs are created. Specifically, two invalid sell OTCs for the user and two invalid buy OTCs for the remote computing device 104. The owner of the contract in the will switch from the user to the remote computing device 104.

### Example Process of Order Matching

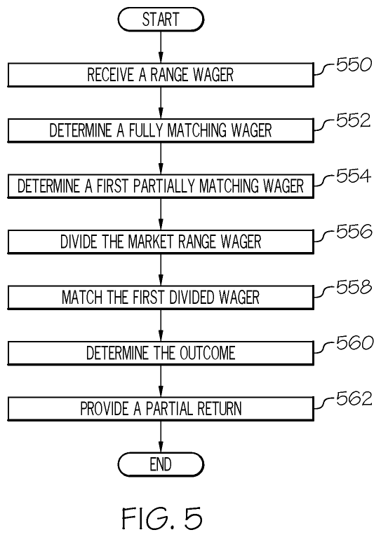

FIG. 5 depicts a flowchart for providing electronic range wagering, according to embodiments provided herein. As illustrated in block 550, a range wager may be received for a first user on an event at a first wager unit amount, where the range wager represents a prediction for an outcome of the event and a variable return is provided based on how close the prediction is to the outcome. In block 552, a determination may be made regarding whether an order book currently records a fully matching wager to the range wager, where the fully matching wager includes a standard match and/or an inverse match. In block 554, in response to determining that the order book does not currently record a fully matching wager, a determination is made regarding whether the order book currently records a first partially matching wager for a second user that was placed with a second wager unit amount that is a fraction of the first wager unit amount of the range wager. In block 556, the range wager may be divided into a plurality of divided wagers, where a first divided wager has a first divided unit amount equal to the second unit wager amount. In block 558, the first divided wager may be matched with the first partially matching wager. In block 560, the outcome for the event may be determined. In block 562, a partial return and/or a partial variable return may be provided, based on the first divided unit amount.

### Example Process of Range Wagering

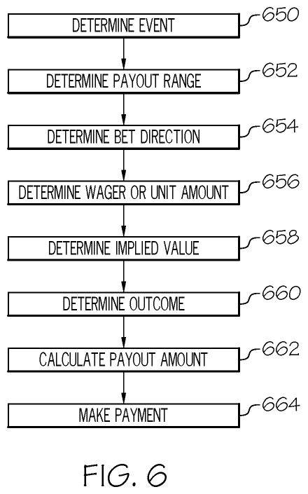

FIG. 6 depicts a flowchart for range wagering, according to embodiments provided herein. As illustrated in block 650, an event for receiving a plurality of wagers may be determined. In block 652, a payout range may be determined from the plurality of wagers, where the payout range includes a high bound and a low bound. In block 654, a bet direction for a wager may be determined. In block 656, the wager or a unit amount for the event may be received from a user. In block 658, an implied value of the event may be determined based on the wager. In block 660, an outcome for the event may be determined. In block 662, a payout amount to the user may be calculated based on where the outcome falls with respect to the range. If the bet direction is an over wager, the payout amount linearly increases from the low bound to the high bound, wherein if the bet direction is an under wager, the payout amount linearly increases from the high to the low bound. In block 664, a payment may be made of the payout amount to the user.

### Example Process of Order Processing

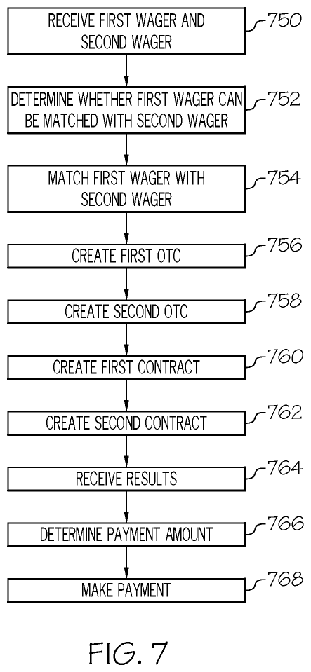

FIG. 7 depicts a flowchart for order processing, according to embodiments provided herein. As illustrated in block 750, a first wager may be received on an event for a first user and a second wager on the event for a second user. In block 752, a determination may be made that the first wager and the second wager can be matched. In block 754, the first wager and the second wager may be matched. In block 756, a first order-to-contract (OTC) may be created for the first user that indicates matching the first wager and the second wager. In block 758, a second OTC is created for the second user that indicates matching the first wager and the second wager. In block 760, a first contract that represents a first portion of matching of the first wager and the second wager may be created. In block 762, a second contract may be created that represents a second portion of matching of the first wager and the second wager. In block 764, data associated with results of the event may be received. In block 766, a payment amount may be determined for at least one of the following: the first user or the second user, based on the first contract, the second contract, and the data. In block 768, a payment of the payment amount may be made.

### Example Computing Device

FIG. 8 depicts a remote computing device 104 for order matching, according to embodiments provided herein. As illustrated, the remote computing device 104 includes a processor 830, input/output hardware 832, a network interface hardware 834, a data storage component 836 (which stores code and line data 838a, order book data 838b, and/or other data, as described with reference to FIGS. 3-5), and a memory component 140. The line data 838a may include information regarding events, participants, wagering lines, etc. The order book data 838b may include contracts, orders, wagers, OTCs, etc. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD) (whether local or cloud-based), and/or other types of non-transitory computer-readable medium. Depending on the particular embodiment, these non-transitory computer-readable mediums may reside within the remote computing device 104 and/or external to the remote computing device 104.

The memory component 140 may store operating logic 842, the range logic 144a, and the matching logic 144b. Each of these logic components may include a plurality of different pieces of logic, each of which may be embodied as a computer program, firmware, and/or hardware, as an example. A local communication interface 846 is also included in FIG. 8 and may be implemented as a bus or other communication interface to facilitate communication among the components of the remote computing device 104.

The processor 830 may include any processing component operable to receive and execute instructions (such as from a data storage component 836 and/or the memory component 140). As described above, the input/output hardware 832 may include and/or be configured to interface with speakers, microphones, and/or other input/output components.

The network interface hardware 834 may include and/or be configured for communicating with any wired or wireless networking hardware, including an antenna, a modem, a LAN port, wireless fidelity (Wi-Fi) card, WiMAX card, mobile communications hardware, and/or other hardware for communicating with other networks and/or devices. From this connection, communication may be facilitated between the remote computing device 104 and other computing devices.

The operating logic 842 may include an operating system and/or other software for managing components of the remote computing device 104. As discussed above, the range logic 144a may reside in the memory component 140 and may be configured to cause the processor 830 to provide range wagering options, such as those described above. The matching logic 144b may be configured for causing a computing device (such as the remote computing device 104) to match wagers and provide functionality related to selling wagers, as described above.

It should be understood that while the components in FIG. 8 are illustrated as residing within the remote computing device 104, this is merely an example. In some embodiments, one or more of the components may reside external to the remote computing device 104 or within other devices, such as the user computing device 102 and/or the third party computing device 106 depicted in FIG. 1. It should also be understood that, while the remote computing device 104 is illustrated as a single device, this is also merely an example. In some embodiments, the range logic 144a and the matching logic 144b may reside on different computing devices, whether physical and/or virtual.

As an example, one or more of the functionalities and/or components described herein may be provided by the remote computing device 104, and/or the user computing device 102. Depending on the particular embodiment, any of these devices may have similar components as those depicted in FIG. 8. To this end, any of these devices may include logic for performing the functionality described herein.

Additionally, while the remote computing device 104 is illustrated with the range logic 144a and the matching logic 144b as separate logical components, this is also an example. In some embodiments, a single piece of logic may provide the described functionality. It should also be understood that while the range logic 144a and the matching logic 144b are described herein as the logical components, this is also an example. Other components may also be included, depending on the embodiment.

As illustrated above, various embodiments for order matching are disclosed. These embodiments may be configured to improve the field of electronic wagering through partial matching of wagers. Specifically, these embodiments can increase the speed at which wagers are matched by breaking one or more of the wagers into wager parts to immediately match with other existing wagers. By improving the speed of matching, these embodiments can accept more wagers and/or more quickly adjust a betting line to more likely ensure that the wagered amounts on each side of a wager are approximately equal.

Other improvements in the technical field of electronic wagering provided herein include entering a wager or cash out amount that queries the order book to determine the number of units to be bought/sold instead of manually doing the calculation to get a unit amount that ties to the wager amount. Other improvements include reducing memory requirements of the remote computing device 104 by adjusting database objects instead of creating new ones each time an order processing event occurs, while still maintaining a proper audit trail. Specifically, embodiments provided herein include order matching and order processing. Order matching includes matching bettors based on price/time and standard/inverse match. Order processing occurs once an order is matched and is the methodology of how OTCs and contracts are created, transferred, adjusted, etc.

Some improvements include increasing betting optionality. Specifically, embodiments provided herein allow user to divide wagers into partials, sell a portion or all of your bet prior to resolution, list a portion or all of your bet for sale and subsequently cancel the order, and list portions of the wager for sale at various prices. Some embodiments provide the ability name a price for a wager that is currently not being offered for a limit order. Some embodiments allows a market maker to offer a predetermined value of wagers at a single price, without having to manually move the line provided in the user interface. This increases the speed at which lines change as price movements are preset. Some embodiments provide the ability to match a single wager with various wagers at the same price or other prices (e.g., straddling two or more price points). Some embodiments calculate and provide wagering lines based on unit prices, increasing the speed at which customers can make wagering decisions. Some embodiments provide a safer wagering construct for users by utilizing range wagering. Additionally, some embodiments save memory to the ability to store unlimited contracts and/or partial contracts in each OTC and contract objects. The speed of processing buy and sell orders is also increased from adjusting existing OTCs based on subsequent sales or resolutions while maintaining audit trail. Additionally, as will be understood, order processing, range wagering, and order matching cannot be performed by a human with pen and paper. First, electronic wagering inherently cannot be performed by a human. Second, the speed required to process a wager, determine a betting line must be almost instantaneous such that the system provides accurate information and closes the wagering at the correct start time of the event. This could not be performed by a human.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums for order matching. It should also be understood that these embodiments are merely exemplary and are not intended to limit the scope of this disclosure.

What is claimed is:

1. A method for increasing speed of electronic transactions through order matching, comprising:
receiving, by a computing device, a range wager for a first user on an event at a first unit amount, wherein the range wager represents a prediction for an outcome of the event and a variable return is provided based on how close the prediction is to the outcome;
determining, by the computing device, a fully matching wager to the range wager is recorded that includes at least one of the following: a standard match or an inverse match;
in response to determining that a fully matching wager is not recorded, determining, by the computing device, that a first partially matching wager is recorded for a second user that was placed with a second unit amount that is a fraction of the first unit amount of the range wager;
dividing, by the computing device, the range wager into a plurality of divided wagers, wherein a first divided wager has a first divided unit amount equal to the second unit amount;
matching, by the computing device, the first divided wager with the first partially matching wager;
determining, by the computing device, the outcome for the event; and
providing, by the computing device, a partial return, based on the first divided unit amount.

2. The method of claim 1, further comprising:
calculating a market range on the range wager, wherein the market range provides the partial return;
providing a user interface for receiving the range wager that depicts the market range; and
receiving the first unit amount for the first user.

3. The method of claim 2, wherein the user interface further provides:
a direction option for the first user to select at least one of the following: an over position in the event, an under position in the event, or a neutral position in the event;
an action option for the first user to select at least one of the following: a buy or a sell; and
an order type option for the first user to select at least one of the following: a market order or a limit order.

4. The method of claim 2, wherein the user interface further provides a payout calculator that allows a user to scroll a plurality of outcomes to the event to calculate an expected payout of the range wager.

5. The method of claim 1, further comprising entering a wager amount queries order book to return a number of units to be matched.

6. The method of claim 1, further comprising displaying betting lines based on unit prices.

7. The method of claim 1, in response to matching the first divided wager with the first partially matching wager, creating an order-to-contract (OTC) and a contract for the first user and the second user.

8. The method of claim 1, further comprising facilitating a sale of the range wager to a third user.

9. A system for increasing speed of electronic transactions via range wagering, comprising:
a computing device that includes a processor and a memory component, wherein the memory component stores logic that, when executed by the processor, causes the system to perform at least the following:
determine an event for receiving a plurality of wagers;
determine a payout range from the plurality of wagers, wherein the payout range includes a high bound and a low bound;
determine a bet direction for a wager;
receive the wager or a unit amount for the event from a user;
determine an implied value of the event, based on the wager;
determine an outcome for the event;
calculate a payout amount to the user, based on where the outcome falls with respect to the range, wherein if the bet direction is an over wager, the payout amount linearly increases from the low bound to the high bound, wherein if the bet direction is an under wager, the payout amount linearly increases from the high to the low bound; and
pay the user the payout amount.

10. The system of claim 9, wherein the wager includes one of the following: a market order or a limit order.

11. A system for increasing speed of electronic transactions via order processing comprising:
a computing device that includes a processor and a memory component, the memory component storing logic that, when executed by the processor, causes the system to perform at least the following:
receive a first wager on an event for a first user and a second wager on the event for a second user;
determine that the first wager and the second wager can be matched;
match the first wager and the second wager;
create a first order-to-contract (OTC) in an order book for the first user that indicates matching the first wager and the second wager;
create a second OTC in the order book for the second user that indicates matching the first wager and the second wager;
create a first contract that represents a first portion of matching of the first wager and the second wager;
create a second contract that represents a second portion of matching of the first wager and the second wager;
receive data associated with results of the event;
determine a payment amount to at least one of the following: the first user or the second user, based on the first contract, the second contract, and the data; and
make a payment of the payment amount.

12. The system of claim 11, wherein the logic further causes the system to perform at least the following:
broker a sale of the first contract for a contract amount from the first user to the second user;
switch the first OTC from a valid label to an invalid label and mark the first OTC as dummy;
create a valid buy OTC specifying a buy price and the contract amount of the first contract for the second user;
create an invalid sell OTC specifying a sale price and the contract amount of first contract for the first user; and
switch an owner of the first contract from the first user to the second user.

13. The system of claim 11, wherein the logic further causes the system to perform at least the following:
broker a sale of a portion of the first contract for a partial contract amount from the first user to the second user;
reduce the partial contract amount and a total cost of the first buy OTC of the first user by amounts transferred to the second user;
split the first contract into two contracts;
transfer the portion of the first contract to the second user;
create a valid buy OTC for the second user, specifying a buy price and the partial contract amount;
create an invalid sell OTC for the first user specifying a sale price and the partial contract amount; and
create a dummy buy OTC for the first user specifying an original buy price and a sold partial contract amount.

14. The system of claim 11, wherein the logic further causes the system to perform at least the following:
receive a limit sell order for the first contract from the first user;
determine that there is no matching posted limit buy order or inverse match sell order available in the order book;
store the sell order as an open order in the order book;
switch the first buy OTC for the first contract listed for sale from valid to invalid in the order book; and
create a valid sell OTC for the first user, specifying a sale price and a partial contract amount.

15. The system of claim 11, wherein the logic further causes the system to perform at least the following:
receive an unmatched limit sale order for a portion of the first contract for a listed amount;
reduce a partial contract amount for the first buy OTC by an amount listed for sale;
split the first contract into two contracts;
create a valid sell OTC for the first user specifying a sale price and the partial contract amount; and
create an invalid buy OTC for the first user for the listed amount.

16. The system of claim 11, wherein the logic further causes the system to perform at least the following:
receive a cancellation request for an open limit sell order prior to the open limit sell order being matched;
switch a sell OTC from valid to invalid; and
switch a buy OTC from invalid to valid.

17. The system of claim 11, wherein the logic further causes the system to perform the following:
broker a sale for the first contract;
switch a first sell OTC from valid to invalid;
switch a buy OTC for the first user from valid to invalid and mark as dummy;
create a valid buy OTC specifying a buy price and a partial contract amount of the first contract for the second user; and
switch an owner user of the first contract from the first user to the second user.

18. The system of claim 11, wherein the logic further causes the system to perform the following:
broker a sale of a portion of the first contract from the first user to the second user;
reduce a partial contract amount and a total cost of the first buy OTC by an amount transferred to the second user;
split the first contract into two contracts;
create a valid buy OTC for the second user, specifying a buy price and the partial contract amount of the first contract;
create an invalid sell OTC for the first user specifying a sale price and the partial contract amount of the first contract;
create an invalid dummy buy OTC specifying the sale price and the partial contract amount; and
transfer the first contract to the second user.

19. The system of claim 11, wherein the logic further causes the system to perform at least the following:
broker a sale of the first contract;
extinguish the first contract by increasing a first account balance of the first user by a sale amount and switching a first owner of the first contract from the first user to an administrator; and
extinguish the second contract by increasing a second account balance of the second user by the sale amount and switching a second owner of the second contract from the second user to the administrator.
